(19) United States
(12) Patent Application Publication
(10) Pub. No.: US 2017/0312762 A1
(43) Pub. Date: Nov. 2, 2017

(54) Portable Multi-Stage Prospecting Centrifuge

(71) Applicant: AU.L, LLC, Bristol, IN (US)

(72) Inventors: LeRoy P. Hershberger, Bristol, IN (US); Perry Hershberger, JR., Bristol, IN (US)

(21) Appl. No.: 15/583,888

(22) Filed: May 1, 2017

Related U.S. Application Data
(60) Provisional application No. 62/329,872, filed on Apr. 29, 2016.

(51) Int. Cl. B04B 9/08; B03B 5/32; B04B 7/16; B04B 15/00

(52) U.S. Cl. CPC B04B 9/08; B04B 15/00; B03B 5/32; B04B 7/16

(57) ABSTRACT

A compact and portable multi-stage centrifuge apparatus comprising a cart, a housing mounted onto the cart, and an engine mounted onto the cart adjacent to the housing, wherein the housing comprises an inlet in the top of the housing, an outlet in the wall of the housing, and a bowl contained within the housing, wherein the bowl comprises an engagement member that is operatively coupled to the engine's drive shaft, such that the bowl can be rotated by engaging the engine, thus removing undesirable materials from the bowl and out of the housing through the outlet.

### CROSS-REFERENCES TO RELATED APPLICATIONS

This application claims priority to and incorporates fully by reference U.S. Provisional Application No. 62/329,872, Portable Multi-Stage Prospecting Centrifuge, filed on Apr. 29, 2016.

### STATEMENT REGARDING FEDERALLY SPONSORED RESEARCH OR DEVELOPMENT

Not applicable.

### BACKGROUND

The present invention is directed to a multi-stage centrifugal ore separation apparatus particularly designed for use in separating gold and other desirable ores from rocks, dirt, debris, or undesired products. More particularly, the present invention relates in its embodiments to a multi-stage centrifuge that is compact and highly portable, for advantageous use in prospecting and for use in remote locations.

It is known to the art to prospect for gold and other desirable ores. After quantities of desirable ore are found, a mine may be established to mine the prospected site. Establishment of the mine often includes the transport and placement of large, costly, and heavy mining equipment, including digging and drilling equipment for enlarging the mine and extracting the ore, and refining equipment for separating ore from other materials. Such refining equipment commonly includes large, heavy centrifuges designed to operate at a fixed location.

Prospectors also have a need for refining equipment to separate gold or other ore from undesired materials. Prospectors, however, often do not operate at or within reasonable proximity to an established mine, or a location with refining equipment. Prospectors are often thus forced to use less-than-optimal means of refining ore in the field, or forced to undertake the time and expense of transporting material from the prospecting site to a remotely-located centrifuge for refinement.

### SUMMARY

The present invention relates generally to a compact, portable, multi-stage centrifuge apparatus for use by prospectors to separate gold or other desired ores from undesired material in the field.

The present invention broadly teaches a cart-mounted centrifuge including a housing, with an inlet in the top of the housing and an outlet located in the wall of the housing near, but raised above, the housing floor, and, within the housing, an upright bowl presenting a sloped inner face with a plurality of inwardly extending, generally horizontal, vertically spaced-apart flights or ribs. A rotatable axle is connected to the bowl bottom and extends downward along the bowl longitudinal axis, supporting the bowl above the housing floor and connecting the bowl, directly or indirectly, to a power source, such as a gas engine. The housing and engine are mounted to the cart in approximate adjacency. The housing inlet may include a lid, or a sieve member, to preliminarily separate material.

In a preferred embodiment, the bowl is of generally frustoconical configuration, with its respective ribs being substantially circular in plan and extending continuously about the inner bowl face. Advantageously, the ribs are arranged such that the inner margin of each rib is located inward relative to the inner margin of the next higher rib. In this fashion, the ribs are arranged in a “stair step” orientation. Further, in this preferred embodiment, the bottom of the outlet aperture is located approximately ½ inch above the floor of the housing, and the portion of the housing wall defined by the gap between the housing floor and the bottom of the outlet aperture serves as an additional point of separation to refine gold or other desired ore from unwanted material.

### BRIEF DESCRIPTION OF THE DRAWINGS

These and other features, aspects, and advantages of the present invention will become better understood with regard to the drawings accompanying herewith.

FIG. 1 shows a perspective view of a preferred embodiment of the present invention;

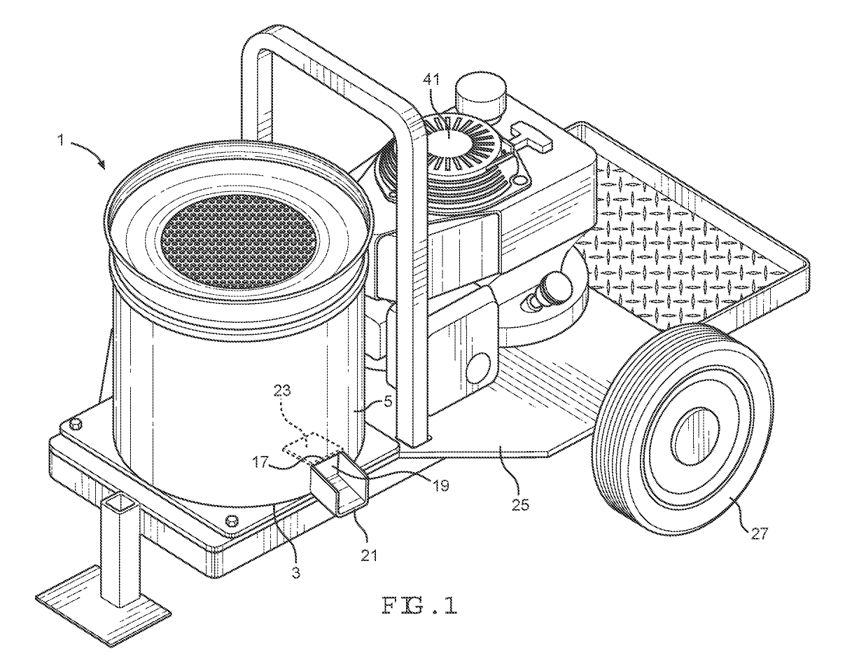

FIG. 2 shows an exploded view of a preferred embodiment of the present invention;

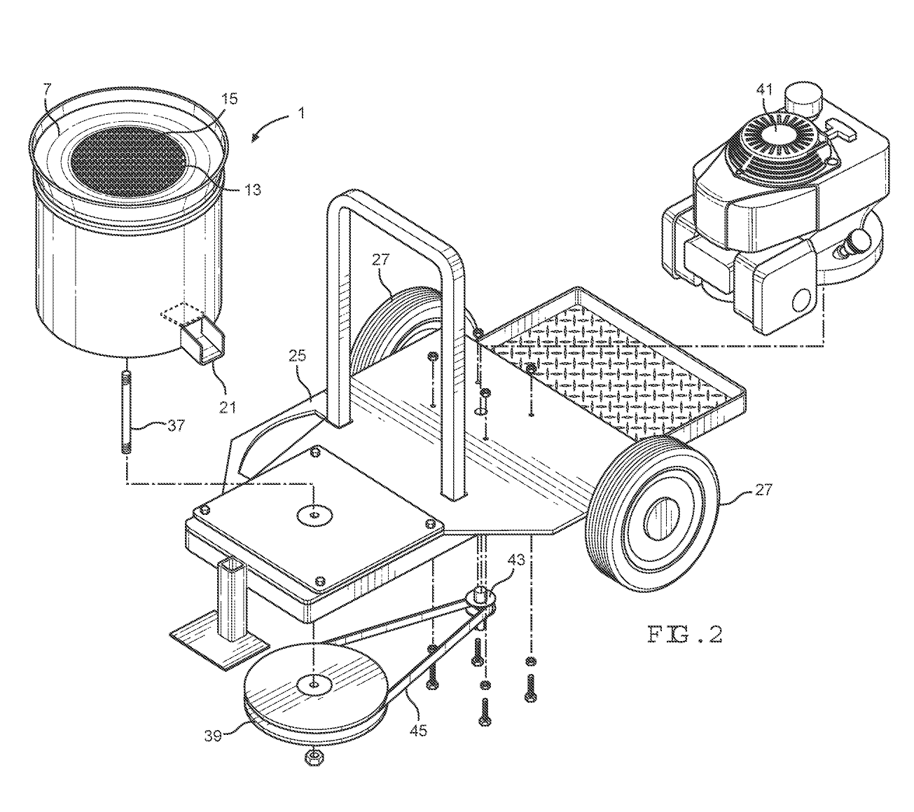

FIG. 3 shows a top-down view of the housing of a preferred embodiment of the present invention;

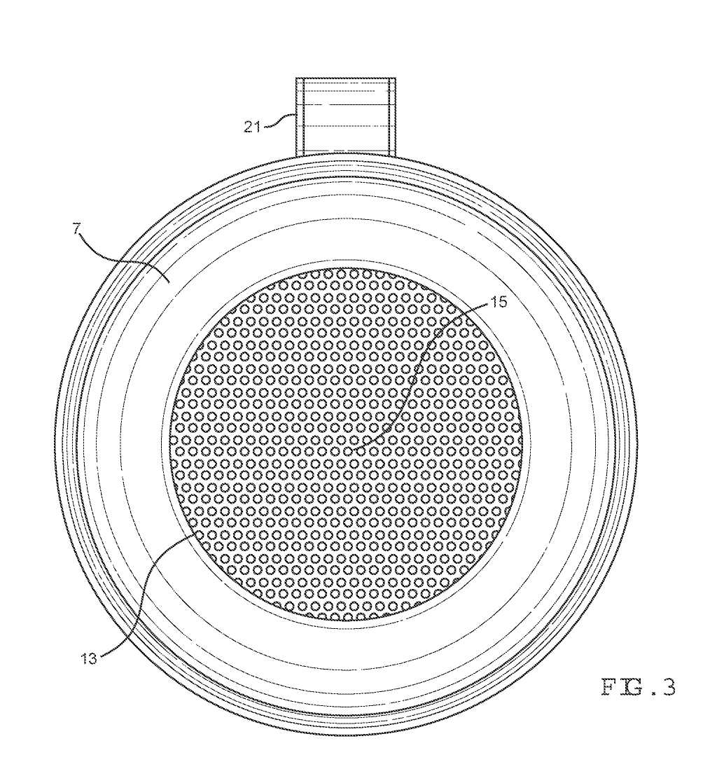

FIG. 4 shows a perspective view of an embodiment of the present invention with the sieve member removed;

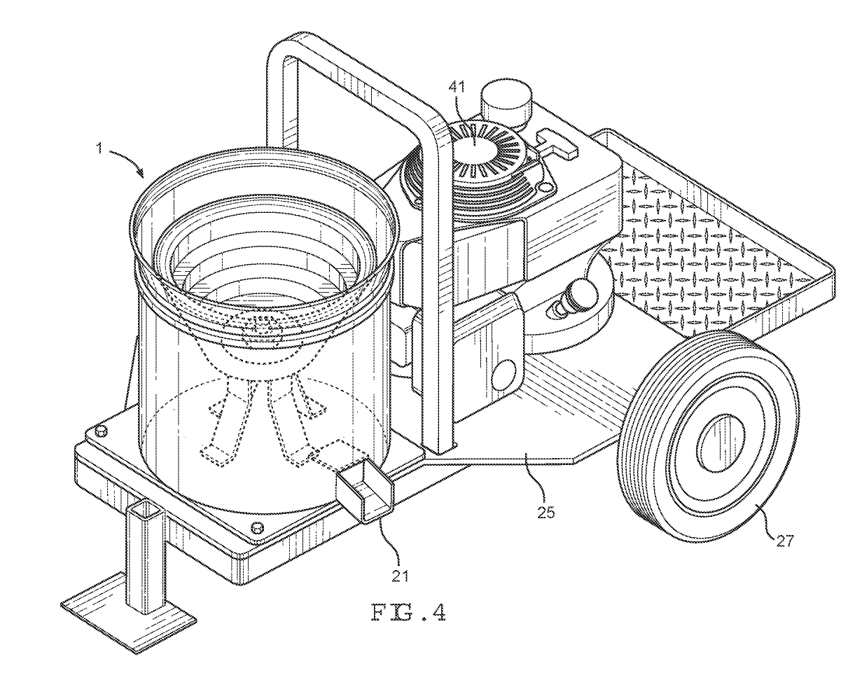

FIG. 5 shows a top-down view of the housing of an embodiment of the present invention with the sieve member removed; and

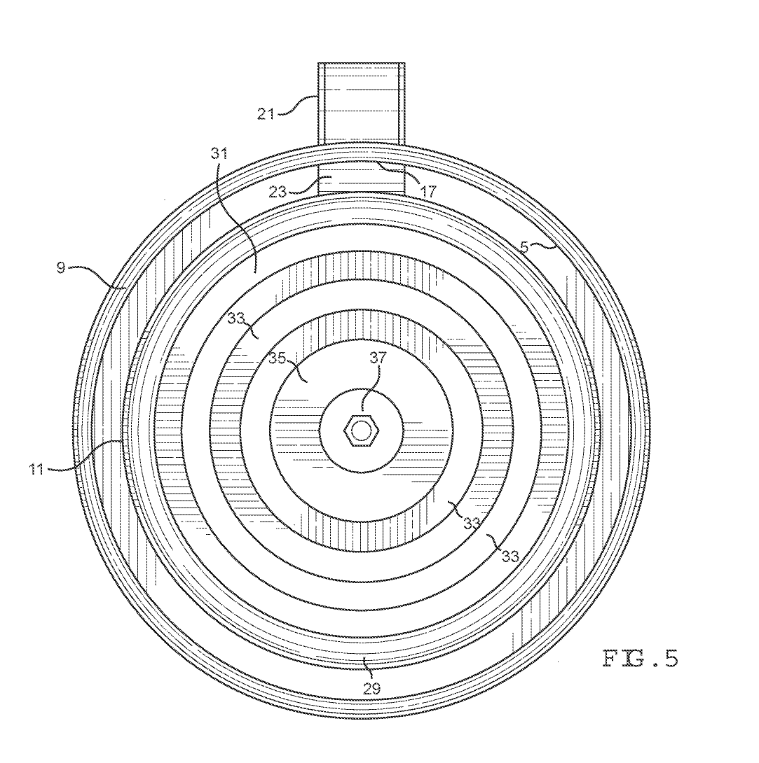

FIG. 6 shows a bottom-up perspective view of a preferred embodiment of the present invention.

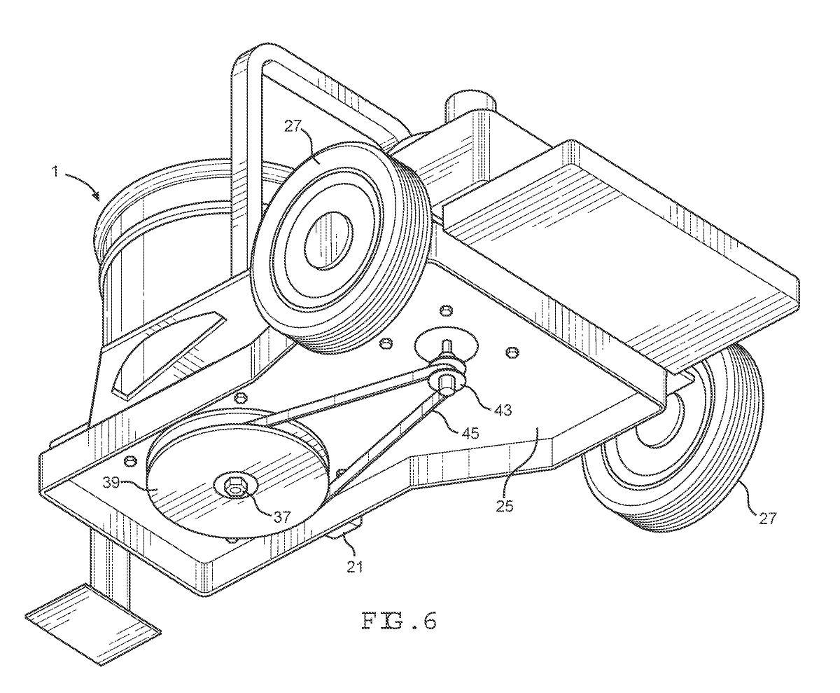

### DETAILED DESCRIPTION

The present invention is directed to a portable multi-stage centrifuge generally comprising a housing (1) with a floor (3), a wall (5) or walls, and a top (7). Preferable materials for the housing (1) include metal and metal alloys, most preferably steel and its alloys. The housing (1) can be a variety of shapes and sizes, but is preferably cylindrical, and preferably has a diameter of 36 inches or less.

The housing (1) includes an inlet (9) near or at its top (7), through which prospecting materials can be introduced to the bowl (11). In a preferred embodiment, the inlet (9) comprises the entirety of the open cylindrical top (7) of the housing (1). In this preferred embodiment, the inlet (9) is fitted with a removable sieve member (13) comprising a porous portion (15), where the porous portion (15) of the sieve member (13) is disposed over the bowl (11) and the placement and size of the porous portion (15) ensures that prospecting material falls into the bowl (11). The sieve member (13) can serve as a first separation step, as would be appreciated by one skilled in the art.

The housing (1) further comprises an outlet (17) located in the housing wall (5) near the housing floor (3). The outlet (17) comprises an aperture (19) through the housing wall (5) through which materials may exit the housing (1) after being centrifuged. In a preferred embodiment, the outlet (17) comprises a rectangular aperture (19), and further comprises a downwardly-angled sluice (21) extending outwardly from the exterior of the housing wall (5) at the bottom of the aperture (19) defined by the outlet (17). The outlet (17) is vertically located near, but not touching, the housing floor (3). The portion of the housing wall (5) defined by the gap between the housing floor (3) and the bottom of the outlet aperture (19) constitutes a site of additional ore separation, as described below. In a preferred embodiment hereof, the bottom of the outlet aperture (19) is located between ¼ inch and 1 inch, and most preferably ½ inch, above the housing floor (3), and the outlet (17) further comprises a lip (23) extending inwardly from the housing wall (5) into said housing (1) adjacent to the top of the outlet aperture (19).

The housing (1) is mounted to a cart (25). The cart (25) may comprise two, four, or any other number of wheels (27), provided it is suitable to support the centrifuge and an engine (41) when in use. Preferably, the cart (25) is configured and designed for use in rough terrain.

A bowl (11) is contained within the housing (1). The bowl (11) is upright in orientation with respect to the housing (1), and the bowl's open face (29) is aligned with the inlet (9) and may additionally be aligned with the porous portion (15) of a sieve member (13). The bowl (11) comprises a sloped inner face (31) with a plurality of inwardly extending, generally horizontal, vertically spaced-apart flights or ribs (33). In a preferred embodiment, the bowl (11) is of generally frustoconical shape and configuration, with the respective ribs (33) being substantially circular in plan, extending continuously about the bowl's inner face (31), and arranged in a stair step orientation, such that the inner margin of each rib (33) is located inward relative to the inner margin of the next higher rib (33), and the bowl (11) has a substantially flat bottom (35).

A rotatable axle (37) is connected to the bottom (35) of the bowl (11) substantially at the bowl's longitudinal center, and extends downwards along the bowl's longitudinal axis. The axle (37) supports the bowl (11) above the housing floor (3) and, preferably, supports the bottom (35) of the bowl (11) at a location above the top of the outlet aperture (19). The axle (37) is rotatable about its longitudinal axis, and is preferably disposed within a bearing for reliable rotation. The axle (37) further comprises an engagement member (39) suitable for operative rotating connection of the axle (37) to an engine (41). Such connection may be direct, or may be indirect and facilitated by, for example, a chain or belt (45). The engagement member (39) may, as would be appreciated by one skilled in the art, comprise a gear, a pulley, or other means commonly used for rotating connection. The axle (37) preferably extends downwardly through the bottom of the housing floor (3) and also through the cart (25), such that the engagement member (39) is disposed beneath the cart.

An engine (41) is mounted to the cart (25) approximately adjacently to the housing (1). The engine (41) may be virtually any reasonably portable power source whose normal function provides vibration and sufficient power to rotate the bowl (11) to desired speeds. In a preferred embodiment, the engine (41) is a 160 cubic centimeter gasoline-powered engine. The engine (41) may be mounted to the cart (25) in any direction from the housing (1), provided the engine (41) is sufficiently adjacent to the housing (1) for vibration from the engine (41) function to translate to the housing (1) and bowl (11). The engine (41) is mounted to the cart (25) so that a drive shaft (43) of the engine (41) is accessible to the engagement member (39). In a preferred embodiment, a hole is cut through the cart (25) and the engine is mounted such that the drive shaft (43) points downwardly and is parallel to the engagement member (39).

The engine's drive shaft (43) is operatively connected to the engagement member (39) to enable relatively high-speed rotation of the axle (37) when the engine (41) is engaged. This connection may be direct or indirect. In preferred embodiments, the engagement member (39) comprises a multi-ribbed pulley, and the drive shaft (43) is operatively connected to it by a belt (45), such that engagement of the engine results in turning of the engagement member (39), and thus the axle (37) and the bowl (11), along the bowl's longitudinal axis.

In use, embodiments of the present invention accomplish two, and potentially three, stages of separation. A slurry of prospected material and water is introduced through the inlet (9). In embodiments in which a sieve member (13) is used, the slurry is introduced through the sieve member (13), and a first separation is accomplished as materials unable to wash through the porous portion (15) of the sieve member (13) are kept out.

Material passes into the bowl (11), which is rotating according to engagement of the engine (41). As slurry enters the bowl (11), it is initially directed in a circular pattern due to the rotation of the bowl (11). As the slurry migrates radially outwardly under the influence of centrifugal force, the slurry encounters the vertically spaced-apart ribs (33) extending inwardly from the sloped inner face (31) of the bowl (11). As rotation proceeds, heavy desired ores such as gold tend to collect atop the respective ribs (33), and are maintained in position because of centrifugal force. However, rocks and other undesirable debris continue to move upwardly during the bowl's continued rotation by virtue of the turbulence created adjacent the inner edges of the ribs (33). The material is lifted and elevated in stepwise fashion until such material passes over the upper rim of the bowl (11), and falls to the housing floor (3). A separation is accomplished as gold or other desired ore remains in the bowl (11) and other material falls to the housing floor (3).

The portion of the slurry that falls out of the bowl (11) to the housing floor (3) may yet retain some quantity gold or other desired ore that was not captured in the bowl (11). The continued inflow of slurry falling to the housing floor (3) from the bowl (11), as well as vibration applied to the housing (1) by the engine (41) and by the function of the axle (37) and bowl (11), agitates the slurry on the housing floor (3). As a function of the agitation, yet another separation occurs, as gold and other desired ores tend to fall to the bottom of the slurry where they are retained by the portion of the housing wall (5) defined by the gap between the housing floor (3) and the bottom of the outlet aperture (19), and undesired materials pass from the housing (1) through the outlet aperture (19).

In this manner, the present invention provides a compact, portable refining apparatus for prospecting use, that provides two, or preferably three, separations to refine gold or other desired ores from other materials.

It will be understood that a variety of embodiments not expressly disclosed herein are yet within the scope and spirit of the present invention, and are encompassed thereby. For example, various methods of providing power, various bowl configurations, various housing shapes, inlet shapes, or outlet shapes, various cart construction designs, and various configurations of the cart, engine, and housing with respect to each other, are all within the scope and spirit of this invention.

What is claimed is:

1. A portable multi-stage centrifuge apparatus, said apparatus comprising:
a. a cart configured to support the centrifuge apparatus;
b. a housing mounted onto said cart, said housing comprising a floor, a wall, a top, an inlet approximately at said housing top, and an outlet in said housing wall near said housing floor, wherein said outlet comprises an aperture through said housing wall through which materials may exit said housing after being centrifuged;
c. a bowl substantially contained within said housing, said bowl comprising an open face, a sloped inner face, and a bottom, wherein said open face is substantially aligned with said inlet, wherein said sloped inner face comprises a plurality of inwardly extending, generally horizontal, vertically spaced-apart ribs, and wherein said bowl further comprises a rotatable axle coupled to said bowl bottom substantially at said bowl's longitudinal center and extending downwardly along said bowl's longitudinal axis, wherein said axle supports said bowl above said housing floor, and wherein said axle further comprises an engagement member suitable for operative rotating connection of said axle to an engine; and
d. an engine mounted onto said cart approximately adjacent to said housing, said engine comprising a drive shaft, wherein said drive shaft is operatively coupled to said engagement member.

2. The apparatus of claim 1, wherein said cart further comprises at least one wheel.

3. The apparatus of claim 1, wherein said housing is cylindrical and has a diameter of 36 inches.

4. The apparatus of claim 3, wherein said housing top is cylindrical and said inlet comprises the entirety of said cylindrical housing top.

5. The apparatus of claim 4, wherein said inlet further comprises a removable sieve member.

6. The apparatus of claim 5, wherein said sieve member further comprises a porous portion disposed over said bowl.

7. The apparatus of claim 1, wherein said aperture is rectangular, and wherein said outlet further comprises a downwardly angled sluice extending outwardly from said housing wall at said aperture.

8. The apparatus of claim 7, wherein said outlet further comprises a lip extending inwardly from said housing wall into said housing adjacent to the top of said aperture.

9. The apparatus of claim 8, wherein said aperture is located approximately ½ inch above said housing floor.

10. The apparatus of claim 1, wherein said bowl is frustoconically shaped, and wherein said ribs are substantially circular, extending continuously about said bowl's sloped inner face, and arranged in a stair step orientation.

11. The apparatus of claim 10, wherein said bowl bottom is substantially flat.

12. The apparatus of claim 1, wherein said axle supports said bowl bottom at a location above said aperture.

13. The apparatus of claim 1, wherein said axle extends downwardly through said housing floor and said cart, such that said engagement member is disposed beneath said cart.

14. The apparatus of claim 13, wherein said drive shaft extends downwardly through said cart and is disposed beneath said cart parallel to said engagement member.

15. The apparatus of claim 14, wherein said engagement member comprises a multi-ribbed pulley, and wherein said drive shaft is operatively coupled to said engagement member by a belt, such that engagement of said engine results in turning of said engagement member, and thus said axle and said bowl, along said bowl's longitudinal axis.

16. The apparatus of claim 1, wherein said engine comprises a 160 cubic centimeter gasoline-powered engine.
